(19) United States
(12) Patent Application Publication
(10) Pub. No.: US 2026/0221852 A1
(43) Pub. Date: Jul. 30, 2026

(54) Winding Method And Machine For Winding Conducting Wire On Pole Pieces Of Electric Motor Rotors

(71) Applicant: MARSILLI S.P.A., Castelleone (IT)

(72) Inventor: Gian Battista PARATI, Castelleone CR (IT)

(73) Assignee: MARSILLI S.P.A., Castelleone, CR (IT)

(21) Appl. No.: 19/143,292

(22) PCT Filed: Dec. 20, 2023
(86) PCT No.: PCT/IB2023/063012

§ 371 Date: Jun. 25, 2025

(30) Foreign Application Priority Data
Feb. 9, 2023 (IT) 102023000002220

(51) Int. Cl. H02K 15/022; B21F 23/00; H02K 1/24

(52) U.S. Cl. CPC H02K 15/022; B21F 23/00; H02K 1/24

(57) ABSTRACT

A method and an automatic winding machine for making high quality windings on pole pieces of rotors of electric motors with the direct in slot winding technique, thus overcoming the problem related to the elasticity of the pack of laminations that defines the body of the rotor, are described. While winding, the conducting wire is guided by means of a wire guiding cap movable in the rotor slots between which the pole piece to be wound at that moment extends. The body of the rotor is compacted by means of a pressing device internal to the wire guiding cap. The axial pressing of the body, performed parallel to the rotation axis Z of the rotor for preventing the umbrella effect, is thus formed thanks to a specific device integrated into the wire guiding cap, i.e. by exploiting the volume inside the wire guiding cap and providing the axial pressing device therein.

### FIELD OF THE INVENTION

The present invention concerns a method of winding conducting wire on pole pieces of electric motor rotors and a corresponding automatic winding machine.

### Known Art

It is known to make electric motor rotors with a body formed by stacking-an in particular by overlapping and pressing-a plurality of metal laminations which stay integral to each other. The body of the rotor defines poles, or pole pieces, on which a conducting wire is wound for forming windings.

The thickness of each lamination is usually equal to a few tenths of a millimeter, for example 0.2-0.4 mm, and the number of stacked laminations is normally of a few hundreds. For example, the body of the rotor of a height equal to 150 mm, made by stacking laminations with a thickness equal to 0.35 mm, has more than 400 laminations.

The laminations are produced by using the metal lamination blanking technique; thus, the thickness of the laminations suffers from a given tolerance. This means that the thickness variations between the laminations, although minimal, for example of a few microns, imply a non-negligible tolerance on the overall height of the body of the rotor. Producers of electric motors that make windings of conducting wire on the body of the rotor must take this tolerance into account.

An even more relevant aspect is that laminations suffer from a thickness tolerance also between different points of the same lamination. This circumstance implies an imperfect overlapping of the laminations throughout their entire surface; a minimal, centesimal or micrometric gap can remain between the individual laminations, with the consequence that the body of the rotor assumes a behavior which can be defined as elastic, with size variations measurable in millimeters. Whenever the body of the rotor is not subjected to axial compressive loads, i.e. compressive loads parallel to the rotation axis of the rotor, the height of the body of the rotor is at its maximum and, vice-versa, whenever the body of the rotor is subjected to axial compressive loads, the height of the body of the rotor is reduced, because the gaps between the laminations are eliminated.

In other words, by applying an axial compressive load to the body of the rotor, the laminations are forced to properly overlap, i.e. each resting over the entire surface of the underlying lamination. By eliminating the load, the body of the lamination suffers a sort of spring back and its height increases, since the laminations return, or almost, to their initial configuration.

In view of the above, it is clear that the height of the rotor body subjected to an axial compressive load is less than the height of the same rotor body in the absence of axial load.

The application of the axial compressive load occurs as a consequence of the winding of the conducting wire on the poles of the body of the rotor. In fact, before being wound on the poles, a winding tension is applied to the conducting wire, i.e. the conducting wire is pretensioned in a specific wire tensioning unit positioned upstream of the body of the rotor with respect to the forward direction of the conducting wire. Thus, as the number of loops effectively wound on the poles of the body of the rotor increases, the compressive load on the body of the rotor increases correspondingly; for example, assuming to be winding a conducting wire of a small diameter with a tension of 1 Kg, and assuming to have made hundreds of winding loops on the poles of the body of the rotor, the corresponding axial compressive load on the body of the rotor will correspond to hundreds of kilograms. Consequently, the first loops are wound on the body of the rotor having an initial height H and the last loops are wound on the body of the rotor having a final height h<H. Whenever the winding has been completed, the last loops will be properly tensioned but not the first, as they will be loose and will thus enjoy a certain freedom of movement which can cause them to be repositioned in the winding and with respect to the rotor pole, which may result in worsening of the quality of the winding layering and of the mechanical and electrical characteristics of the finished rotor in general.

The drawback described above is particularly felt in the event of rotors with wound poles, even more so compared to rotors with unwound poles, as the substantially cantilevered shape of the pole pieces with respect to the central part of the body of the rotor, i.e. with respect to the rotating shaft, amplifies the elastic behavior of the body itself, thus generating what is often defined as the “umbrella effect”. Since the windings of conducting wire on a pole piece provide incremental layering in the radial direction towards the outside of the rotor, the number of wires in the winding in proximity of the rotor shaft is less than the number of wires in the winding away from the shaft. The compression exerted by the winding is thus not applied in a uniform way on the pole piece, but it is greater at the free end of the pole piece with respect to the base constrained to the shaft of the rotor; if not appropriately corrected, this difference results in deformation of the pack of laminations and the body of the rotor would assume an “umbrella-like” shape.

The following two techniques for winding conducting wires on the pole pieces of electric motor rotors and their respective winding machines or coil winder are further known:
needle winding, commonly defined by the English expression as needle winding technology, which provides the use of a wire guiding needle moved in the rotor slots along the desired deposition path, with a rotor that is stationary or rotating alternately on its own rotation axis, for the controlled release of the wire on the pole piece, and
direct in slot winding, commonly defined by the English term in slot technology, which provides the use of a metal cap for guiding the wire into the rotor slots. The wire guiding cap is mounted on a tailstock of the winding machine and the tailstock is movable in the radial direction with respect to the rotor to be wound. The wire guiding cap moves forward and backward in the rotor slots to guide the deposition of the conducting wire on the pole pieces according the desired layering pattern.

Normally, whenever using the needle winding technique, removable vises are used for preventing the umbrella effect and ensuring the proper layering of the conducting wire, which removable vises are applied to the body of the rotor to preload the pack of laminations, i.e. to apply the axial compressive load necessary for minimizing the height of the body of the rotor, before performing the winding. The removable vises used to compact the pack of laminations (which defines the body of the rotor) are generally provided with two opposite jaws movable away from and towards each other, and springs interposed between the jaws for constantly exerting a return force which tends to bring them towards each other. The springs, which have an adjustable preload, are temporarily extended to allow to fit the respective vise on the body of the rotor and, once the vise has been mounted on the body of the rotor, they exert a force which tends to tighten the vise, thus moving the jaws that apply the provided axial load on the pack of laminations towards each other. In short, the producers of electric motors provide to mount a sufficient number of vises on the body of the rotor before starting to wind the conducting wire on the poles. The vises stay on the body of the rotor throughout the entire winding operations and are removed only after winding is completed. This solution allows producers to make windings while keeping the height of the body of the rotor and the tension of the conducting wire of each loop constant. The presence of the vises does not disturb the movement of the wire guiding needle: the vises thus stay clinging to the outside of the pole piece, parallel to the shaft of the rotor, i.e. arranged in the axial direction, and the wire guiding needle is inserted into the rotor slots following a path bypassing both the pole piece and the respective vise. As set forth above, the vise is removed from the pole piece only once the winding has been completed and the wire guiding needle has been moved away. The vises are collected from a repository, mounted on the pole pieces of the rotor and put away after use by means an automatic device.

The solution just described is however not usable with direct in slot winding (in slot technology) due to the presence of the tailstock of the winding machine, which tailstock would be occupying exactly the space otherwise used by the vise. In fact, the tailstock must abut against the pole piece in the radial direction to extend the wire guiding cap inside the rotor slots, and this would not be possible in the presence of a vise.

JP 2012 135077 describes a winding machine for direct in slot winding, in which the tailstock abuts against the pole piece and exerts radial pressure thereon, i.e. pressure in a direction orthogonal to the rotation axis of the rotor.

JP H02 111245 A describes a machine similar to the previous one. Moreover, the machine is provided with an anti-rotation element identified by reference number 14 in FIG. 2. The anti-rotation element is dovetail-shaped for engaging the pole piece by a shape coupling used to prevent relative rotation between the pack of laminations and the tailstock. The anti-rotation element is not designed to exert pressure on the pole piece.

### SUMMARY OF THE INVENTION

Object of the present invention is to provide a method and an automatic winding machine (coil winding machine) which allow to make high quality windings on the pole pieces of electric motor rotors with the direct in slot winding technique, thus overcoming the problem related to the elasticity of the pack of laminations that defines the body of the rotor.

A first aspect of the present invention thus concerns a method according to claim 1.

While winding, the conducting wire is guided by means of a wire guiding cap movable in the rotor slots delimiting the pole piece to be wound at that moment.

Advantageously, the method provides for pressing the body of the rotor by means of a pressing device internal to the wire guiding cap. The pressing of the body in the axial direction, i.e. parallel to the rotation axis Z of the rotor, performed for preventing the umbrella effect, is thus achieved thanks to a specific device integrated into the wire guiding cap.

By exploiting the volume inside the wire guiding cap and arranging the pressing device therein, the technical problem is solved, thus being able to axially compact the body of the rotor subjected to winding by compensating the elasticity of the pack of laminations.

The axial pressing exerted while winding the conducting wire on the pole piece, parallel to the rotation axis of the finished rotor, keeps the height of the pack of metal laminations that constitutes the body of the rotor to a minimum; this way, the elasticity of the coupling between the metal laminations is compensated.

Preferably, the axial pressing is exerted throughout the entire winding of the conducting wire on the pole piece and is thus started right before beginning to wind and ended right after the winding has been wound.

The winding of the conducting wire on the pole piece is performed with an automatic winding machine. The following methods (flyer, rotating spindle) are for example possible:
keeping the body of the rotor stationary and simultaneously moving the wire guiding cap in the rotor slots, along an approach axis Y radial with respect to the rotation axis Z of the rotor, alternately in both directions, and winding the conducting wire on the wire guiding cap, which in turn provides to deposit it on the pole piece according to a solution definable as in slot flyer winding, or
moving the wire guiding cap in the rotor slots along an approach axis Y, alternately in both directions, and simultaneously rotating both the spindle with the body of the rotor and the wire guiding cap as well as the pressing device integrated into the wire guiding cap on the approach axis Y, integrally and kept constrained (the pressing device to the body of the rotor and the body of the rotor to the spindle), according to a solution definable as rotating spindle in slot winding.

In other words, the winding machine can be configured such as the conducting wire is wound about the wire guiding cap, which provides to position it properly on the pole piece (flyer winding), otherwise the rotor and the cap rotate together, thus pulling the conducting wire on the wire guiding cap and, therefore, on the pole piece (rotating spindle winding).

Preferably, in the automatic winding machine, the wire guiding cap is susceptible to controlled displacements along the approach axis Y, in both directions and radially with respect to the rotation axis Z of the rotor supported by the spindle. The wire guiding cap is sized such as to substantially enclose a pole piece of the rotor and the pressing device is a vise integrated into the wire guiding cap. The method further provides to modify the sizes of the wire guiding cap for adapting it to the pole piece of the rotor, correspondingly to the instantaneous position assumed by the wiring guiding cap in the rotor slots.

Preferably, while winding the conducting wire, the pressing device constantly exerts axial pressure on the body of the rotor, i.e. a pressure parallel to the rotation axis Z of the rotor, and the rotor, the wire guiding cap and the pressing device rotate integrally, i.e. synchronously, about the approach axis. Once wound, whenever the rotor is kept stationary with respect to an external system of reference, the wire guiding cap is removed from the pole piece, i.e. disengages the rotor and the pressing device is deactivated to disengage the rotor.

Preferably, the axial pressure is exerted by the pressing device on the body of the rotor at the edge of the pole piece.

Preferably, the movements of the wire guiding cap are dependent upon the activation or deactivation of the pressing device; this prevents the winding machine from being able to continue to wind the conducting wire whenever the body of the rotor is not kept at the minimum height, i.e. at the minimum axial extent (axis Z).

The method can be implemented by providing to be able to adjust the pressure axially exerted by the pressing device on the body of the rotor; this makes it possible to adapt the winding machine to rotors of different sizes, i.e. having a body with a different number of metal laminations.

A second aspect of the present invention concerns an automatic machine according to claim 10, intended to make windings of conducting wire on the pole pieces of electric motor rotors.

The machine comprises:
a spindle or support provided with means for supporting the body of a rotor;
a tailstock movable with respect to the spindle along an approach axis Y, between a proximal position for engaging the body of the rotor supported by the spindle, and a distal position for disengaging the body of the rotor;
a unit for feeding the conducting wire.

The tailstock comprises a wire guiding cap movable with respect to the spindle between a position of maximum insertion of the wire guiding cap into the rotor slots of the body of the rotor supported by the spindle, in particular the slots between which a pole piece extends, and a position of minimum insertion or disengagement, at which the wire guiding cap does not engage said rotor slots and, thus, does not engage the pole piece.

Advantageously, the winding machine comprises an axial pressing device arranged inside the wire guiding cap and configured to press the body of the rotor in the direction parallel to the rotation axis Z of the finished rotor, i.e. the axis Z on which the rotor is intended to rotate when assembled together with the respective stator; thus, the axial pressing occurs parallel to the height of the pole piece.

The inner volume of the wire guiding cap is exploited to contain the pressing device, which allows the body of the rotor to be compacted, thus preventing the umbrella effect without hindering the conducting wire winding operations. The solution suggested thus allows windings of improved quality to be formed without increasing machine cycles, i.e. within the same times as solutions without pressing.

Preferably, the pressing device is adjustable for exerting a calibrated axial pressure on the body of the rotor, in particular a pressure sufficient to counteract the elasticity of the body, due to the constraint between the respective stacked metal laminations, and to compact it up to the minimum height. Axial pressure adjustment allows to set the winding machine on rotors of different sizes, thus making the machine versatile.

In the preferred embodiment, the pressing device can be operated throughout the entire winding. This ensures that the tension of each loop of the winding is equal to the tension of the other loops of the same winding, whenever considering providing a pretensioned conducting wire. Alternately, it is possible to also consider deactivating the pressing device before having completed the winding, whenever a number sufficient of loops has been wound on the pole piece and the body of the rotor can no longer suffer a springback of the metal laminations.

In a first embodiment, whenever the winding machine is in use, the body of the rotor is kept stationary in the spindle or support (with respect to an external system of reference, for example in the environment in which the machine is found) and the wire guiding cap is simultaneously moved in the rotor slots along the approach axis Y, alternately in both directions. The conducting wire provided by the feeding unit is wound on the wire guiding cap, which in turn provides to deposit it on the pole piece. In practice, the feeding unit rotates about the approach axis Y to bring the conducting wire on the wire guiding cap while the latter is moving in the rotor slots, to deposit the conducting wire in the proper position.

In a preferred second embodiment, while the winding machine is working, the wire guiding cap is moved in the rotor slots along the approach axis Y, alternately in both directions, and the machine simultaneously provides to rotate the spindle together with the body of the rotor, the wire guiding cap and the pressing device integrated into the wire guiding cap integrally on the approach axis Y. Thus, in this embodiment, the feeding unit feeding the conducting wire does not move, as it is the wire guiding cap which, by rotating on the approach axis Y, draws the conducting wire back.

Preferably, the body of the rotor is supported by the spindle or support, with the rotation axis Z of the rotor orthogonal and incident to the approach axis Y. The wire guiding cap is susceptible to controlled displacements along the approach axis Y, in both directions. The wire guiding cap is sized such as to substantially enclose the pole piece of the rotor to be wound with the conducting wire. The pressing device is a vise integrated into the wire guiding cap, i.e. internal to the wire guiding cap and synergistically working therewith to exert axial pressure on the pack of laminations, i.e. parallel to the rotation axis Z of the rotor.

Preferably, the spindle, together with the body of the rotor supported therein, the wire guiding cap and the vise integrated into the wire guiding cap are rotatable integrally on the approach axis Y, i.e. as a whole.

Preferably, the rotation of the wire guiding cap and vise on the approach axis Y is dependent upon the activation of the vise on a least one edge of a pole piece of the body of the rotor, so that the deposition of the conducting wire occurs with the guarantee that the body of the rotor has been axially compacted and will not suffer the umbrella effect.

In the preferred embodiment, the pressing device is a vise. The vise comprises two jaws movable radially with respect to the approach axis Y and thus parallel to the rotation axis Z of the rotor supported by the spindle. The jaws are movable between a distal position, corresponding to the vise open, and a proximal position corresponding to the vise closed. With the vise open, it is possible to disengage the body of the rotor and to abut against it. With the vise closed, the jaws apply pressure on the body of the rotor to compact it to the minimum axial extent (with respect to the axis Z).

The vise can be of various types, for example hydraulic, but is preferably mechanical; a vise actuator is mounted on the tailstock. The actuator comprises a drive shaft extending on the approach axis Y, a lever system constrained to the jaws and one or more springs constantly exerting a return force on the jaws to bring them to the proximal closed position of the vise. With this configuration, the vise normally stays in the closed position and the actuator intervenes to temporarily bring it to the open position. The machine can further be configured with reversed kinematics, i.e. with the springs that tend to open the vises and the actuator that keeps the vises closed. The operation of the vise provides the displacement of the drive shaft on the approach axis Y, between:
a position of engagement of the lever system, at which the lever system counteracts the action of the springs and keeps the jaws in the distal open position of the vise, and
a position of disengagement, at which the drive shaft does not exert thrust on the lever system sufficient to counteract the action of the springs and the jaws are in the proximal closed position of the vise. The alternating movement of the drive shaft of the vise on the approach axis Y can be imparted, for example, by an electric linear actuator.

In an alternate embodiment, vise operation can be achieved by providing an actuator with radial movement with respect to the rotation axis.

In the preferred embodiment, the wire guiding cap is mounted on a rotation shaft rotatable on the approach axis. The drive shaft of the vise is inside and coaxial to the rotation shaft of the wire guiding cap. As will become clearer in the description hereunder, this configuration allows the synchronous rotation of the drive shaft of the vise and of the rotation shaft of the wire guiding cap, whenever the conducting wire is wound on a pole piece of the rotor, and allows the relative movement of the drive shaft of the vise inside the rotation shaft of the wire guiding cap along the approach axis Y, whenever the vise must be open to disengage the rotor.

The integration of the vise in the wire guiding cap is thus achieved thanks to this configuration of the respective actuators, which share the space in the inner volume of the wire guiding cap. The vise does not thus occupy a space outside the wire guiding cap.

The wire guiding cap is of variable geometry for adjusting its size to the geometry of the pole piece while winding and, in particular, to fit the rotor slots during the movements made by the wire guiding cap along the approach axis Y, radially with respect to the rotation axis Z of the rotor, between the positions of minimum insertion and maximum insertion. The wire guiding cap has a generic conical shape and, thus, its complete insertion into the rotor slots would not be possible without interference if the geometry of the wire guiding cap was not modifiable.

Preferably, the wire guiding cap is defined by two halves arranged on opposite sides with respect to the pressing device, i.e. the vise. The two halves of the wire guiding cap are movable, radially with respect to the approach axis Y, away and towards each other, to modify the size of the wire guiding cap and allow its insertion into the rotor slots.

The operation of the winding machine provides to position the body of a rotor on the spindle, with a pole piece facing the tailstock; before starting to rotate the spindle and body of the rotor, the tailstock is brought to abutment against the body of the stationary rotor, at the pole piece to be wound with the conducting wire, and the pressing device (the vise) is operated to compact the body of the rotor. The spindle is started to keep the body of the rotor rotating on the approach axis Y and, simultaneously, the tailstock rotates with the spindle and the body of the rotor. The conducting wire slides on the outer surface of the wire guiding cap which deposits the conducting wire according to the predefined winding pattern by moving forward and backward in the rotor slots, until the winding has been completed. Whenever the winding has been wound on the pole piece, the spindle and the tailstock are stopped, i.e. the rotation on the approach axis Y is interrupted and the pressing device is deactivated to release the body of the rotor; the tailstock is moved away from the spindle and the body of the rotor is rotated on its rotation axis Z to bring a new pole piece to face the tailstock, ready for a new winding cycle.

### BRIEF LIST OF THE FIGURES

Further characteristics and advantages of the invention will become clearer in the review of the following detailed description of its preferred, although not exclusive, embodiments illustrated by way of example and without limitations with the aid of the accompanying drawings, in which:

FIG. 1 is a perspective and elevation view of a rotor with wound poles, which rotor is made by using the method and the machine of the present invention;

FIG. 2 is an elevation and axial sectional view of a rotor portion, in particular of one of its pole pieces, combined with a vise and prearranged for winding the conducting wire according to the known needle winding technique;

FIG. 3 is a perspective bottom view of the rotor portion shown in FIG. 2 and of the vise;

FIG. 4 is a bottom view of the rotor portion shown in FIG. 2 and of the vise;

FIG. 5 is a perspective and elevation view of a needle winding machine (coil winding machine), according to the known art, and of a rotor with poles wound while winding the conducting wire;

FIG. 6 is a perspective view of a winding machine (coil winding machine) according to the present invention;

FIG. 7 is a top view of the machine shown in FIG. 6;

FIG. 8 is a front and elevation view of a first portion of the machine shown in FIG. 6, defined spindle, and of the rotor subjected to winding;

FIG. 9 is a side, elevation and partial sectional view of the spindle portion of the machine shown in FIG. 6 and in FIG. 8;

FIG. 10 is a plan, top and partial sectional view of the spindle portion of the machine shown in FIG. 6 and in FIG. 8;

FIG. 11 is an isometric view of the spindle portion of the machine shown in FIG. 6 and in FIG. 8;

FIG. 12 is a perspective and elevation view of a second portion of the machine shown in FIG. 6, defined tailstock;

FIG. 13 is a vertical sectional view of the tailstock of the machine shown in FIG. 6 and in FIG. 12;

FIG. 14 is a sectional plan view of the tailstock of the machine shown in FIG. 6 and in FIG. 12, considered on the plane of section B-B of FIG. 13;

FIG. 15 is an isometric and vertical (axial) sectional view of the tailstock of the machine shown in FIG. 6 and in FIG. 12;

FIGS. 16-19 are sectional plan views of the machine shown in FIG. 6, in four corresponding configurations during the step of depositing the conducting wire on a pole piece of a rotor of electric motor;

FIGS. 20-23 are vertical (axial) sectional views of the tailstock of the machine shown in FIGS. 6, 12 and 16-19, in four corresponding configurations during the step of depositing the conducting wire on a pole piece of a rotor of electric motor.

### DETAILED DESCRIPTION OF THE INVENTION

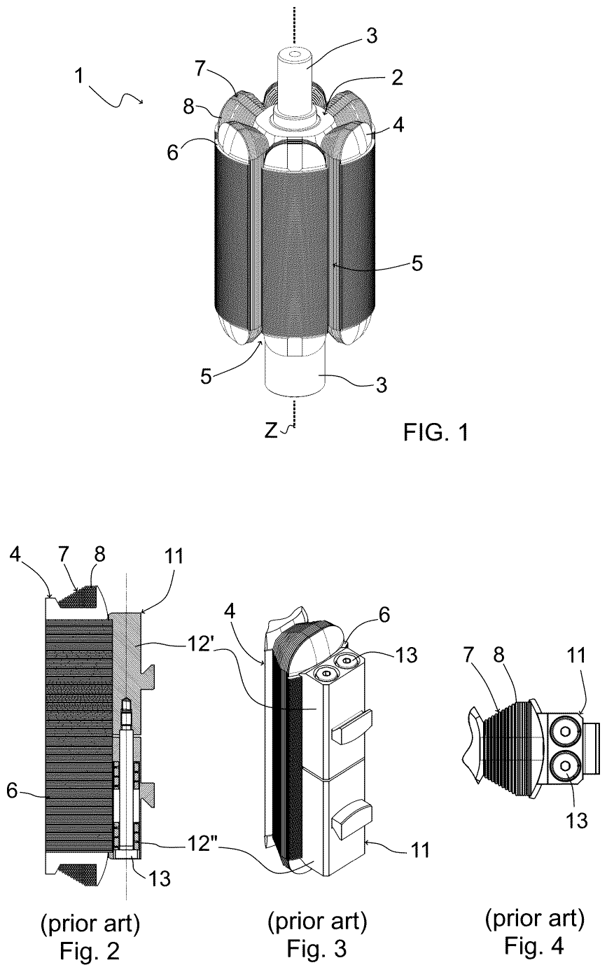

FIG. 1 shows a rotor 1 with wound poles, which is intended for assembling an electric motor. The rotor 1 comprises a body 2 having a shaft 3 intended for rotating on a rotation axis Z, and a plurality of pole pieces 4 extending radially from the rotation shaft 3 and between which the rotor slots 5 are defined.

The body 2 of the rotor 1 is a pack of stacked metal laminations: the number of reference 6 denotes a single lamination, in particular the last one on top. A winding 7 of conducting wire 8, for example a copper wire, is made about each pole piece 4.

A rotor 1, like the one shown in FIG. 1, can be formed with the needle winding technology or with the in slot technology.

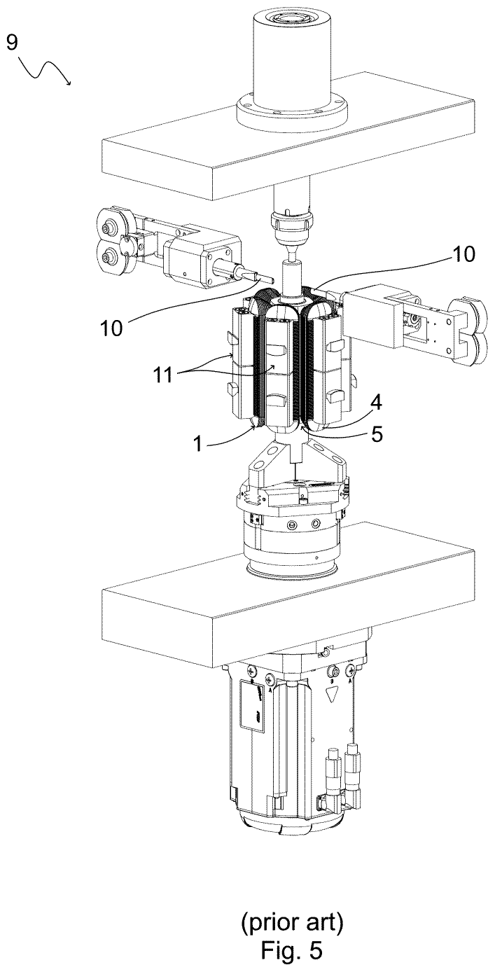

FIG. 5 shows a winding machine (coil winding machine) 9 according to the known art and provided with two wire guiding needles 10 fed with the conducting wire 8 and movable about the pole pieces 4 and in the rotor slots 5 for deposing the conducting wire according to the desired layering pattern, and thus for making the windings 7. The vertical movement (axial and parallel to the axis Z of the rotor 1) of the wire guiding needles 10 is synchronized with the alternating rotary movement of the body 2 of the rotor about the axis Z.

FIGS. 2-4 show a portion of the rotor 1, in particular a pole piece 4 of the rotor 1, while making the winding 7 in the needle machine 9 shown in FIG. 5. As can be noted in FIGS. 2-5, at the pole piece 4, the body 2 of the rotor is compressed axially by a vise 11 having the task of axially compacting (axis Z) the pack of metal laminations 6 which define the body 2 of the rotor. As can be seen from FIG. 5, all the pole pieces 4 of the rotor 1 are combined with a corresponding vise 11, so that the umbrella effect described above does not occur while winding in the needle machine 9. Each vise 11 is provided with two jaws 12′ and 12″ movable, in the axial direction, away from each other to open the vise 11, and towards each other to tighten the vise 11. The tightening force is exerted by springs positioned inside the vise 11 and whose preload is adjustable by screws 13. As described with reference to the known art, the vises 11 are initially open and thus each fit (preassembled) on a pole piece 4 of the rotor 1, before putting the rotor 1 into the machine, i.e. before positioning the body 2 of the rotor 1 in the winding machine 9 and proceeding to perform the winding of the pole pieces 4 with the conducting wire 8. At the end of this operation, whenever the rotor 1 is complete with the windings 7, the rotor 1 is removed from the machine 9 and the vises 11 are open and removed from the body 2 of the rotor 1.

As can be noted by observing FIGS. 2-5, the size of the vises 11 cannot be neglected: this size does not prevent the insertion of the wire guiding needles 10 into the rotor slots 5 and does not thus compromise the execution of the winding in a needle machine, such as the machine 9, but is not compatible with the winding technique defined as in slot technology, which provides the insertion of a metal wire guiding cap into the rotor slots and the rotation of the body 2 of the rotor on an axis orthogonal to the axis Z.

This is where the present invention comes into play, which invention concerns an in slot technology winding method and machine which allow to form high quality windings on the rotors with wound poles, without using vises 11.

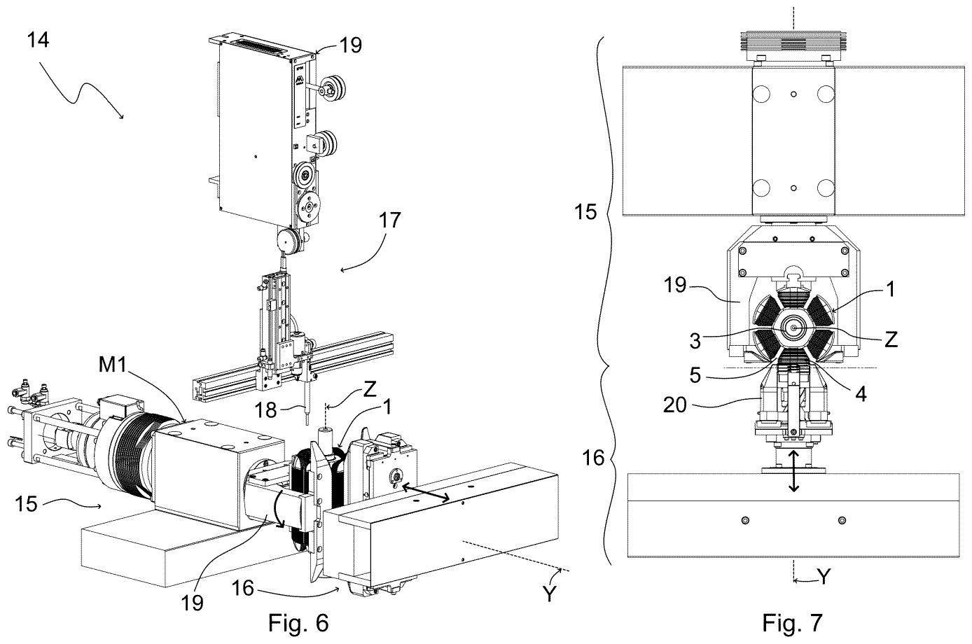

FIGS. 6 and 7 show an automatic winding machine (coil winding machine) 14 according to the present invention, as a whole, for windings of the in slot type.

The automatic winding machine 14, henceforth simply machine 14 or winding machine 14, comprises three main units: the spindle unit 15, the tailstock unit 16 which for simplicity will be named spindle 15 and tailstock 16, and a feeding unit 17 for feeding the conducting wire.

The feeding unit 17 comprises a wire guiding tube 18 fed with conducting wire by a wire tensioning device 19 having the task of keeping the conducting wire at the nominal tension throughout the entire winding procedure on the rotor 1. As can be noted, the feeding unit 17 is located above the spindle 15 and the tailstock 16, so that the wire guiding tube 18 is more or less aligned with the end of the tailstock 16.

The spindle 15 and the tailstock 16 face each other from opposite sides with respect to the rotor 1 or are, in other words, arranged diametrically opposite to the rotation axis Z of the rotor 1. The spindle 15 is provided with a fork 19 in which the body 2 of the rotor 1 is locked while winding the conducting wire. The fork 19 is rotated by the spindle 15 about the axis Y orthogonal to the rotation axis Z of the rotor 1, defined as approach axis Y. The rotation of the rotor 1 about the axis Y causes the pole piece 4, which is from time to time facing the tailstock 16, to rotate like a spool on which the conducting wire can be wound with the number of desired loops and according to the desired layering pattern. Clearly, once a pole piece 4 has been completed, i.e. the winding 7 has been completed thereon, the rotor 1 is rotated about the axis Z with respect to the fork 19 to bring a new pole piece 4 to face the tailstock and start the respective winding. The rotation of the rotor about the axis Z, with respect to the fork 19, is thus intermittent and whenever the rotor 1 does not rotate about the axis Z, it is rotated about the axis Y to perform a winding on one of its pole pieces 4, and vice-versa, until all windings 7 have been completed. The rotation of the fork 19 and, thus, of the rotor 1 about the axis Y is controlled by an electric motor M1.

The tailstock 16 is provided with different functions, as will be described hereunder.

The tailstock 16 is provided with a metal cap 20 used for guiding the conducting wire 8 on the pole piece 4 during the winding procedure. For this reason, the wire guiding cap 20, henceforth simply cap 20, is movable along the axis Y and thus radially with respect to the rotation shaft 3 of the rotor 1, alternately in both directions (also with respect to the same tailstock 16), for being inserted into the rotor slots 5, thus enclosing the pole piece 4, and for guiding the conducting wire 8 while the rotor 1 is rotated about the axis Y, thus forming the desired layering.

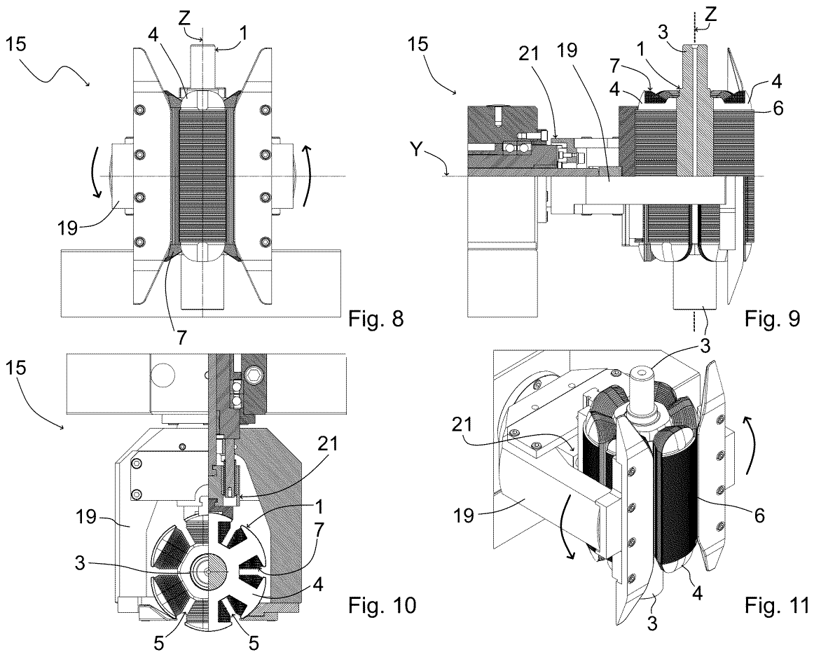

FIGS. 8-11 show the spindle 15 in greater detail. In particular, view 8 shows a front and elevation view of the spindle 15 with a rotor 1 inserted into the fork 19, as “seen” by the tailstock. FIG. 9 shows the spindle 15 in a side, elevation and partial sectional view with the rotor 1 locked in the fork 19. FIG. 10 shows the spindle 15 in a top plan and partial sectional view with the rotor 1 locked in the fork 19. As can be noted, the fork 19, which is openable, holds the rotor 1 tightly so as to prevent undesired movements of the rotor 1 with respect to the same fork 19. Once the winding 7 on the pole piece 4 shown in FIG. 8 has been completed (the pole 4 facing the tailstock 16), the fork 19 is partially open to allow the rotor to rotate about the axis Z for bringing a new pole piece 4 into the position shown in FIG. 8, closing the fork 19 once again and starting a new winding 7 of conducting wire. FIG. 11 is a perspective view of the spindle 15 and the rotor 1. In addition to opening the fork 19, the spindle 15 is provided with a linear actuator 21 having the task of locking the rotor 1 together with the fork 19, by tightening the rotor against the end of the fork 19. The rotation about the axis Y is shown by the arrows in FIGS. 8 and 11 and can be counterclockwise, as shown in the figures, or clockwise.

Summarizing, the tailstock 16 is thus movable towards and away from the spindle 15 along the axis Y, and the rotor 1, positioned on the spindle 15 with its rotation axis Z orthogonal to the axis Y, is rotated precisely about the axis Y in a clockwise or counterclockwise direction.

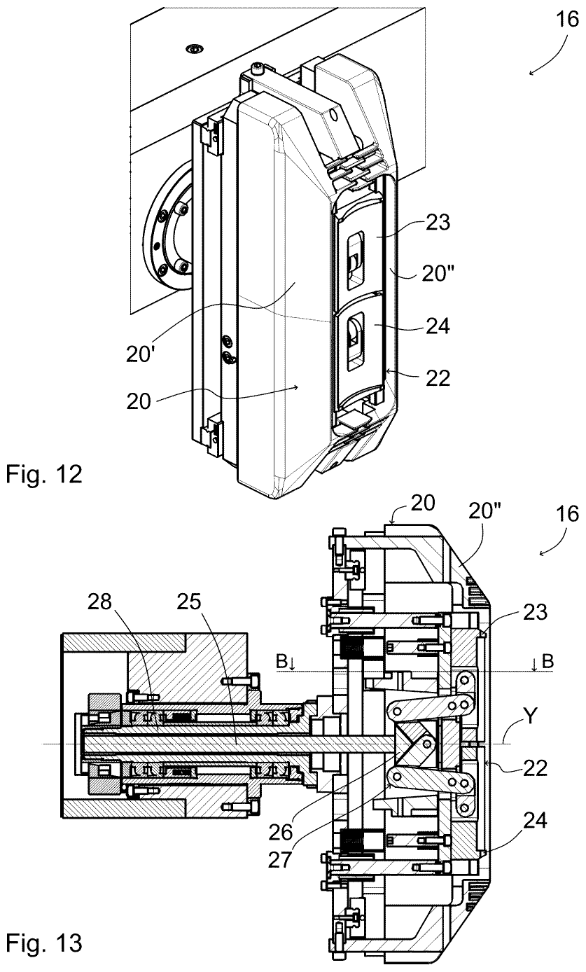

FIGS. 12-15 show the tailstock 16. In particular, FIG. 12 is a perspective view of the tailstock 16 shown on the side facing the spindle 15 and, thus, towards the rotor 1 and one of its pole pieces 4, the one on which the conducting wire is to be deposited. As can be noted, the metal cap 20 is mounted on the tailstock 16 and is movable with and/or relative to the same tailstock 16 along the axis Y, towards the spindle 15 and away from it. The cap 20 is expressly shaped for being inserted into the rotor slots 5 of the rotor 1, thus enclosing a pole piece 4 and engaging the two rotor slots 5 placed to the right and left of that pole piece 4. For this reason, the cap 20 has a main extent in height, parallel to the rotor 1.

The tailstock 16 is movable between a retracted position, of complete disengagement of the rotor 1, and a forward position, defined position of abutment, at which the tailstock abuts against the pole piece 4 of the rotor 1 shown in FIGS. 8 and 11, i.e. the pole piece 4 which remains accessible via the fork 19 in the direction Y.

The cap 20 is movable between a forward position, corresponding to its maximum insertion into the rotor slots 5 of the rotor 1, and a retracted position of minimum insertion into the rotor slots 5 of the rotor 1.

The winding of the conducting wire 8 on the pole piece 4 occurs with the cap 20 inserted into the rotor slots 5: the desired layering of the conducting wire 8 on the pole piece 4 is achieved by appropriately controlling the alternating movement of the cap 20 on the axis Y between the forward position and the retracted position, i.e. the desired shape of the winding 7 is achieved.

The tailstock 16 further comprises a vise 22 integrated therein, in particular inserted into the cap 20 and having the task of compacting the body 2 of the rotor 1 at the pole piece 4 while being wound.

The vise 22 comprises two jaws 23 and 24 movable between a proximal position and a distal position for respectively compacting the body 2 of the rotor 1 and disengaging the body 2 of the rotor 1. As can be noted in FIG. 12, the jaws are shaped concave for being complementary to the convexity of the radially outer surface of the pole pieces 4 of the rotor 1, thus allowing to bring the tailstock 16 to abutment against the pole piece 4, thus resting the jaws 22, 23 against the pole 4.

Once the rotor slots 5 extend radially with respect to the shaft 3 of the rotor 1, the shape of the cap 20 is modifiable to allow its insertion into the slots 5, i.e. to fit its shape. In particular, the cap 20 is defined by two halves 20′ and 20″ remaining on opposite parts with respect to the vise 22. The two halves 20′ and 20″ of the vise 20 are movable away from and towards each other, and with respect to the vise 22 halfway in-between them, so that the two halves 20′ and 20″ correspondingly move closer to the angle at the center intercepted by the windings 7 on the pole pieces 4 when the cap 20 moves from the retracted position to the forward position and, vice-versa, the halves 20′and 20″ move away when the cap 20 moves from the forward position to the retracted position.

The making of the windings 7 on the pole pieces 4 of the rotor 1 is thus achieved by combining the following movements:
movement for rotating the spindle 15 and the rotor 1 about the axis Y;
movement for moving the cap 20 forward and backward on the axis Y, radially with respect to the rotation axis X of the rotor 1;
movement for opening and closing the cap 20, i.e. for opening and closing the halves 20′ and 20″.

The operation of the tailstock 16 and, in particular, of the cap 20 and the vise 22 will be described in detail hereunder with reference to the remaining figures.

FIG. 13 shows the tailstock 16 in vertical sectional and elevation view, i.e. in a section considered on a vertical plane passing through the rotation axis Z of the rotor 1 (before rotating about the axis Y), as shown in FIGS. 6-11. The sectional plane is also a symmetry plane of the vise 20.

As can be noted, the vise 20 is provided with a drive shaft 25 arranged along the axis Y for driving the jaws 23, 24. The drive shaft 25 has a first end inserted into the body of the tailstock 16 supported by bearings, and a second wedge-shaped end intended for engaging an articulated quadrilateral lever system 27. Such lever system 27 is hinged both to the body of the tailstock 16 and to the jaws 23, 24, so that:
the forced insertion (thrust imparted by an actuator) of the wedge-shaped end 26 into the lever system 27 results in the opening of the vise 20, i.e. the moving away of the jaws 23, 24; the same result is achievable with a toggle mechanism;
the return of the drive shaft 25 to the initial position results in the automatic closing of the vise 20, i.e. the moving towards each other of the vises 23, 24 by preloaded springs (not visible in FIG. 13).

This configuration allows to hold tightly the jaws 23, 24 against the pack of laminations 6 that defines the body 2 of the rotor 1 at the pole piece 4 and to thus prevent the umbrella effect.

Since the tailstock 16 must rotate about the axis Y to perform the winding of the conducting wire, the drive shaft 25 is mounted rotatable about the axis Y. An actuator controls the axial displacements of the drive shaft 25 on the axis Y, whereas the rotation is imparted by further components, as set forth hereunder, i.e. the drive shaft 25 is driven to rotate about the axis Y while the conducting wire 8 is being deposited.

The drive shaft 25 is inserted coaxially into a rotation shaft 28 of the cap 20, which has the task of driving the cap 20 to rotate about the axis Y synchronously with the rotation of the rotor 1 about the same axis Y: during this rotation, the rotor 1 rotates integrally with the fork 19 and the cap 20 about the axis Y. Precisely, the rotation shaft 28 of the cap 20 also rotates the drive shaft 25 of the vise 22, specifying that the shaft 25 is also sliding inside the shaft 28 to open and close the vise 20.

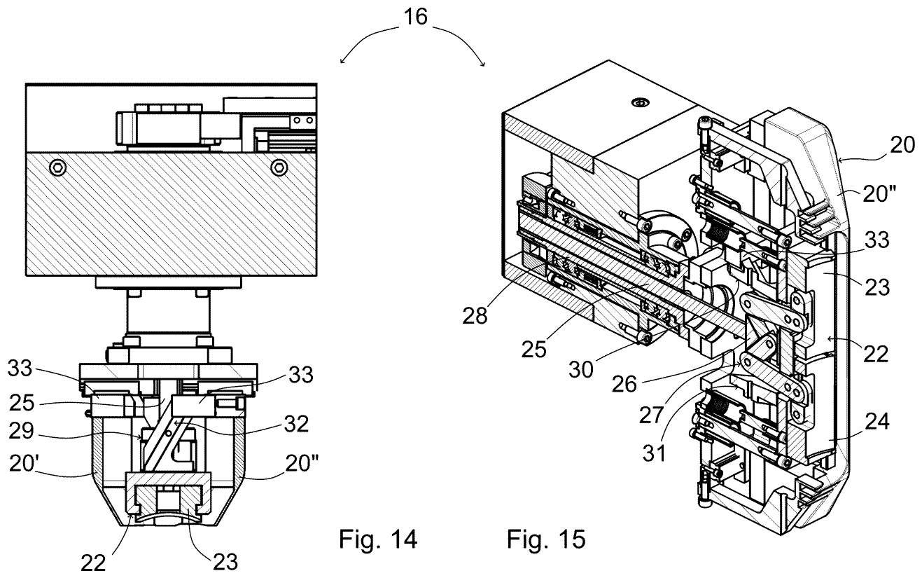

FIG. 14 shows the tailstock 16 on the plane B-B of FIG. 13 in a plan, top and partial sectional view; FIG. 15 shows the tailstock 16 in perspective and vertical sectional (elevation) view. As can be noted, inside the cap 20, an actuator 29 for actuating the two halves 20′ and 20″ of the cap 20 is present between the vise 22 and the body of the tailstock 16. The actuator 29 comprises guides or tracks 32 skewed with respect to the axis Y and inclined to each other by an angle corresponding to the angle formed by the pole pieces of the rotor being machined, of 60° as shown in the example (six poles, 360°/6=60°; with eight poles, the angle would be 360°/8=45°). The guides 32 engage corresponding guides 33 of the halves 20′ and 20″ of the cap 20. The axial movement of the actuator 29 along the axis Y causes the displacement of the guides 32, which impart a thrust to the guide 33 of the two halves of the caps 20′ and 20″, thus resulting in the control of their opening and closing. This way, the cap 20 can be widened and narrowed to fit the space available depending on the position of the rotor slots 5.

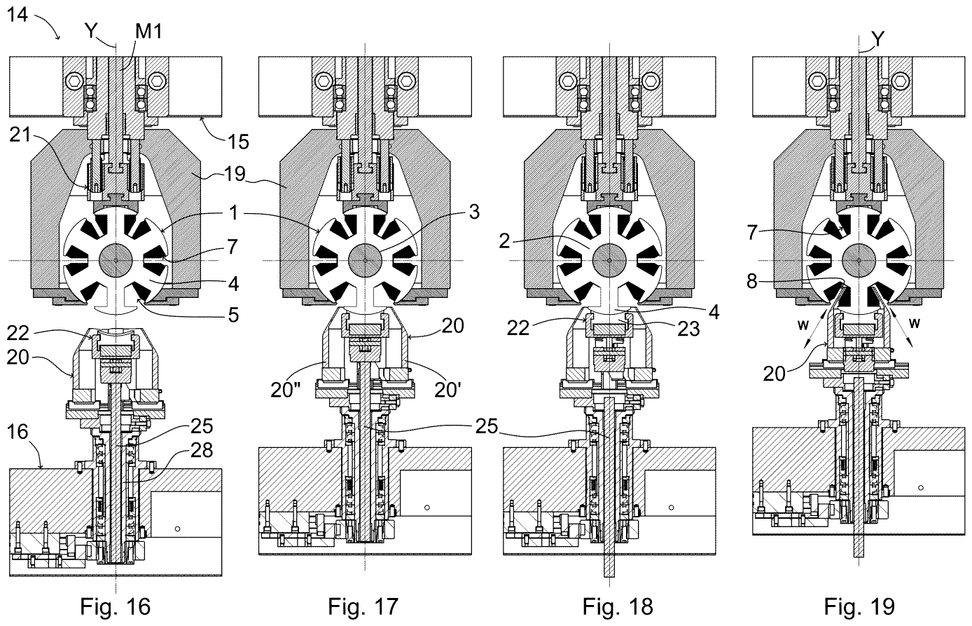

FIGS. 16-19 show, in time sequence, the movement for inserting the cap 20 into the rotor slots 5 of the rotor 1 mounted on the spindle 15. In particular, the figures are plan and sectional views of the winding machine 14, the section being considered on a horizontal plane containing the axis Y and orthogonal to the axis Z.

In the configuration shown in FIG. 16, definable as stand-by configuration, the spindle 15 and the tailstock 16 are facing each other, thus staying away from each other, along the axis Y. The tailstock 16 is in the retracted position ready for being brought to abutment against the rotor 1 held in place by the spindle 15 and, in particular, locked between the fork 19 and the actuator 21. The rotor 1 is stationary in this configuration. A single pole piece 4 is accessible from the outside of the fork 19 for the tailstock 16, the pole 4 facing from the fork 19. Whenever needed, the rotor can be unlocked to allow it to partially rotate and be locked again whenever a new pole piece 4 is aligned with the tailstock 16.

In the configuration shown in FIG. 17, definable as engagement configuration, the tailstock 16 is shown in the abutment position: the body of the tailstock 16 was displaced forward, towards the spindle 15, and the two halves 20′ and 20″ of the cap 20 enclose the end of the pole piece 4 furthest from the rotation shaft 3 of the rotor 1; the vise 22 is in abutment against the outer surface of the pole piece 4, thus resulting complementary thereto in shape. Both the rotor 1 and the fork 19 as well as the tailstock 16 are stationary. The vise 22 is open, i.e. the drive shaft 25 is in its forward position with the wedge-shaped end 26 inserted into the lever system 27, i.e. the jaws 23 and 24 are open, in the distal position. The jaw 23 is above the pack of metal laminations 6 defining the body 2 of the rotor 1 and the jaw 24 is below the same pack of laminations 6.

In the configuration shown in FIG. 18, definable as pressing configuration, the vise 22 is closed, i.e. the jaws 23 and 24 were brought closer together to tighten the pack of laminations 6 defining the body 2 of the rotor 1. This way, the compacting of the body 2 of the rotor 1 was achieved, at least at the pole piece 4 against which the tailstock 16 is in abutment. The closing of the vise 22 is achieved by moving the drive shaft 25 of the vise 22 backward with respect to the body of the tailstock 16: this can be noted by comparing FIGS. 17 and 18. The moving back of the drive shaft 25 also causes the moving back of the wedge-shaped portion 26, with the consequence that the lever system 27 yields to the return force exerted by the springs (not shown) for bringing the jaws 23 and 24 to the proximal position. In this configuration, the body 2 of the rotor 1 is compacted similarly to what is shown in FIGS. 2-4 in relation to the known art, in the sense that the umbrella effect is prevented by not applying an external vise 11 to the pole pieces 4, but by using a vise 22 integrated into the tailstock 16 of the winding machine and operated by the same actuators as those of the tailstock 16 and not by external actuators.

Once the body 2 of the rotor 1 has been compacted, the winding of the conducting wire 8 begins.

In the configuration shown in FIG. 19, definable as layering configuration, the machine 14 is shown while winding. Although the rotor 1 is shown in the same position as in FIGS. 16-18, the reader should imagine it rotating clockwise or anticlockwise about the axis Y: the rotor is rotated about the axis Y by the spindle 15, as described previously, while it stays locked between the fork 19 and the linear actuator 21. Simultaneously with the rotation of the body 2 of the rotor 1 about the axis Y, the vise 22 stays tightened on the pole piece 4 and rotates integrally with the rotor 1 about the axis Y. Thus, while the body 2 of the rotor 1 is rotating, it cannot spread out in the axial direction, i.e. parallel to the axis Z of the rotor 1, by the effect of the springback of the pack of laminations 6. Simultaneously with the rotation of the body 2 of the rotor 1 about the axis Y, the tailstock 16 makes alternating displacements in both directions along the same axis Y, thus determining the insertion of the metal cap 20 into the rotor slots 5 delimiting the pole piece 4 on which the conducting wire is wound at that moment on the sides.

The alternating movement for inserting and removing the cap 20 into/from the rotor slots 5 is denoted by the arrows W in FIG. 19. It is not a simple translation movement since the rotor slots 5 have a substantially radial extent: the two halves 20′and 20″ of the cap 20 must also mutually move towards and away from each other, and thus towards and away with respect to the axis Y, such as to adapt to the rotor slots 5 during the forward movement of the cap 20, with the dual purpose of preventing interference with the body 2 of the rotor and following the path needed to make the desired layering of the conducting wire 8.

Thus, the cap 20 is subjected to different movements: a forward and backward movement on the axis Y, an opening and closing movement, i.e. a movement towards and away of the halves 20′and 20″, and a rotary movement about the axis Y, considering that also the cap 20 rotates integrally with the body 2 of the rotor 1 while winding, like the vise 22.

Observing FIG. 19, the reader should image that the conducting wire 8 is fed continuously and pretensioned by the feeding unit 17 through the guiding wire tube 18 and thus extends orthogonal to the plane of FIG. 19. While winding, the conducting wire 8 rests against the cap 20 which guides its deposition on the rotating pole piece 4. The forward and backward movement of the cap 20 along the axis Y thus causes the conducting wire 8 to be layered. In FIG. 19, the conducting wire 8 is shown (out of scale for instructive purposes) in cross section.

Once the winding 7 has been completed, the machine 14 stops the rotation of the spindle 15, bringing back the rotor 1 with the vertical axis Z, retracting the tailstock 16 and thus extracting the cap 20 from the rotor slots 5 and opening the vise 22. At this point, the rotor 1 is rotated about the axis Z for bringing a further pole piece 4 to interact with the tailstock 16, as explained above, and making the winding 7.

The operations described above are repeated for all pole pieces 4 until completing the rotor 1.

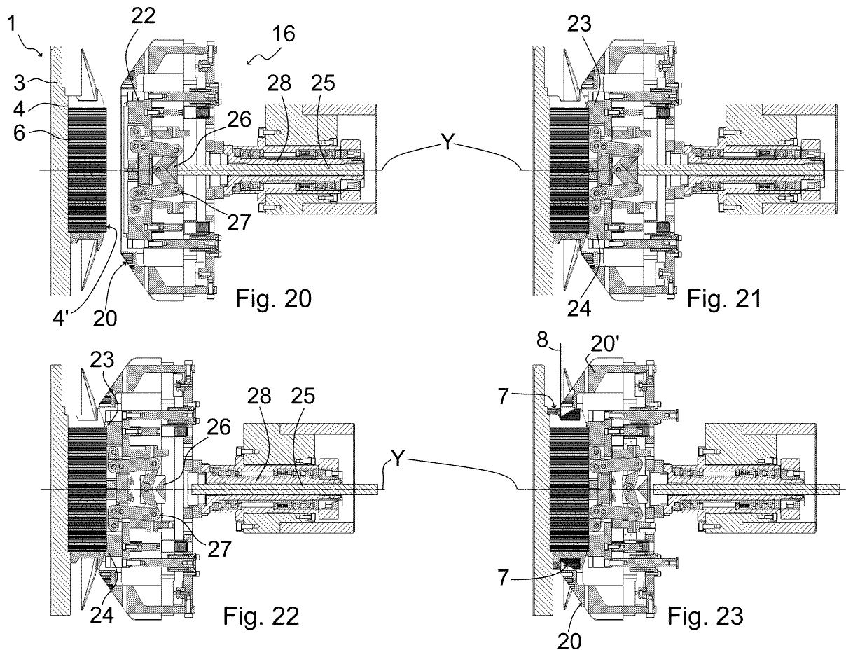

FIGS. 20-23 are vertical sectional, i.e. elevation, views of the tailstock 16 and part of the spindle 15 in the four configurations shown in FIGS. 16-19. In other words, the figures correspond in pairs: FIG. 16 with FIG. 20, FIG. 17 with FIG. 21, FIG. 18 with FIG. 22, FIG. 19 with FIG. 23, and show four corresponding operative steps in time succession: stand-by, engagement, pressing and layering.

In FIG. 20, the machine 14 is shown in the stand-by configuration, with the drive shaft 25 of the vise 22 in the forward position: the vise 22 is open with the jaws 23 and 24 open wide, i.e. distal, by the effect of the force exerted by the lever system 27 which in turn receives the thrust of the wedge-shaped end 26 of the drive shaft 25. In this configuration, the distance between the jaws 23 and 24 is sufficient for allowing the insertion of the pack of laminations 6 defining the body 2 of the rotor 1 at the pole piece 4 between them. The tailstock 16 is spaced from the spindle 15 and the rotor 1 but is ready for the juxtaposition.

FIG. 21 shows the machine 14 in the engagement configuration: the tailstock 16 is advanced on the axis Y until the vise 22 is brought to abutment against the side surface 4′of the pole piece 4 which is stationary together with the spindle 15. The jaws 23 and 24 enclose the pack of metal laminations 6.

FIG. 22 shows the machine 14 in the pressing configuration of the rotor 1: the drive shaft 25 of the vise 22 was drawn back (by an actuator) from the position previously shown, with the consequence that the wedge-shaped end 26 has disengaged the lever system 27. The closing of the vise 22, i.e. the displacement of the jaws 23 and 24 to the proximal position and the corresponding pressing of the pack of lamination 6, as described previously, is determined by no longer counteracting the action of the springs. The spindle 15 and the tailstock 16 are now stationary on the axis Y and the body 2 of the rotor 1 cannot suffer the umbrella effect.

FIG. 23 shows the machine 14 in the layering configuration, i.e. while winding. The spindle 15 and the tailstock 16 rotate integrally (synchronously) about the axis Y. The vise 22 stays tightened for keeping the body 2 of the rotor 1 compacted. The conducting wire 8, coming from the feeding unit 17 and pretensioned by the wire tensioner 19, is fed continuously to the tailstock 16, in particular on the cap 20. In order to achieve the desired layering with a smaller number of loops in the proximity of the axis Z and a greater number at the sector of the pole 4 distant from the axis Z, such as for example shown in FIG. 23, the tailstock 16 and/or the cap 20 move along the axis Y in both directions to guide the conducting wire 8, while the rotor 1 is kept rotating about the axis Y and while the vise 22 keeps the body 2 pressed. During the alternating movements of the cap 20 along the axis Y, the vise 22 always stays tightened on the body 2 of the rotor 1, to prevent the umbrella effect. The cap 20 moves along the axis Y in both directions and simultaneously rotates about the axis Y together with the spindle 15 and the rotor 1. Once the winding 7 has been completed, the procedure is repeated until all windings of the rotor 1 have been completed.

The winding machine 14 thus allows to perform the in slot winding of the rotors 1, thus a winding which provides the insertion of the cap 20 into the rotor slots 5 between the pole pieces 4, without needing external vises whose size would make it impossible to bring the tailstock 16 to abutment against the side surface 4′ of the pole piece 4, and using instead a vise 22 integrated into the tailstock, i.e. positioned inside the cap 20 and operated by an actuator shared with the cap 20.

Integration of the vise 22 and the cap 20 provides the use of the drive shaft 25 for operating the vise 22 (through springs and the lever system 27) and the use of the rotation shaft 28 of the cap 20. The shafts 25 and 28 are coaxial with respect to the axis Y, with the drive shaft 25 inside the rotation shaft 28: the two shafts are dependent from each other: whenever the vise 22 is open, the drive shaft 25 is sliding inside the rotation shaft 28, i.e. translates therein. When the vise 22 is tightened on the body 2 of the rotor 1, the two shafts 25 and 28 rotate integrally.

By exploiting the inner volume of the cap 20, it is possible to make space for the vise 22 without overcomplicating the structure of the tailstock 16, with the advantage of solving the problem of the umbrella effect also in the in slot winding technique.

The solution of integrating the vise 22 inside the cap 20 is also feasible in an alternative embodiment of the winding machine, in which the winding of the conducting wire 8 is achieved by keeping the body 2 of the rotor 1 stationary on the spindle 15, i.e. without rotating the body 2 of the rotor 1 about the axis Y and, thus, without even rotating the cap 20 and the vise 22, and by using a rotating system for feeding the conducting wire 8 which, rotating about the axis Y, winds the conducting wire 8 on the cap 20 which guides it on the pole piece 4. In this embodiment, not shown in the figures, the spindle 15 can simply be a non-rotating support and the feeding unit 17 rotates about the approach axis Y for winding the conducting wire 8 on the wire guiding cap 20, which in turn controls the deposition path in the winding 7 around the pole piece 4.

1. A method of making a winding (7) of conducting wire (8) on a pole piece (4) of a rotor (1) of electric motor, by means of in slot technique, wherein, while winding, the conducting wire (8) is guided by means of a wire guiding cap movable in the rotor slots between which said pole piece extends, characterized by axially pressing the body of the rotor by means of a device internal to the wire guiding cap.

2. Method according to claim 1, wherein the body of the rotor consists of a pack of stacked metal laminations and the axial pressing, exerted while winding the conducting wire on the pole piece, parallel to the rotation axis (Z) of the rotor, keeps the height of the pack of metal laminations to a minimum, by compensating the possible elasticity of the coupling between the metal laminations.

3. Method according to claim 1, wherein the pressing is exerted throughout the entire winding procedure of the conducting wire on the pole piece.

4. Method according to claim 1, wherein the winding of the conducting wire on the pole piece is performed with an automatic winding machine, according to one of the following ways:
by keeping the body of the rotor stationary and simultaneously moving the wire guiding cap in the rotor slots, along an approach axis (Y), alternately in both directions, and by winding the conducting wire on the wire guiding cap, which in turn provides to deposit it on the pole piece, or
by moving the wire guiding cap in the rotor slots along an approach axis (Y), alternately in both directions, and simultaneously and integrally rotating on the approach axis (Y) both the spindle with the body of the rotor and the wire guiding cap, as well as the pressing device integrated into the wire guiding cap.

5. Method according to claim 4, wherein the rotor has its rotation axis (Z) and, in the automatic winding machine, the wire guiding cap is susceptible to controlled displacements along the approach axis (Y), in both directions and radially with respect to the rotation axis (Z) of the rotor, and wherein the wire guiding cap is sized such as to substantially enclose a pole piece of the rotor, and wherein the pressing device is a vise integrated into the wire guiding cap.

6. Method according to claim 5, wherein:
while winding the conducting wire, the vise constantly exerts axial pressure on the body of the rotor, and the rotor, the wire guiding cap and the vise rotate integrally, i.e. synchronously, on the approach axis (Y);
once wound, whenever the rotor is kept stationary, the wire guiding cap is removed from the pole piece, i.e. disengages the rotor, and the vise is opened to disengage the rotor.

7. Method according to any one of the preceding claims claim 1, wherein the axial pressure is exerted on the body of the rotor at the edge of the pole piece.

8. Method according to claim 1, wherein the movements of the wire guiding cap are dependent upon the activation or deactivation of the pressing device.

9. Method according to claim 1, wherein the axial pressure exerted by the pressing device on the body of the rotor is adjustable.

10. A winding machine of in slot type, for making windings of conducting wire on the pole pieces of rotors of electric motor, comprising:
a spindle or support provided with means for supporting the body of a rotor;
a tailstock movable with respect to the spindle along an approach axis (Y), between a proximal position for engaging the body of the rotor supported by the spindle, and a distal position for disengaging said body of the rotor;
a unit for feeding the conducting wire;
wherein the tailstock comprises a wire guiding cap movable with respect to the spindle between a position of maximum insertion of the wire guiding cap into the rotor slots of the body of the rotor supported by the spindle and a position of minimum insertion, or disengagement, at which the wire guiding cap does not engage said rotor slots;
characterized by comprising a pressing device arranged inside the wire guiding cap and configured to axially press the body of the rotor.

11. Winding machine according to claim 10, wherein the pressing device is adjustable for exerting a calibrated axial pressure on the body of the rotor, parallel to the rotation axis (Z) of the rotor, in particular a pressure sufficient to counteract the elasticity of the body of the rotor and to compact said body to the minimum height.

12. Winding machine according to claim 10, wherein the pressing device can be operated throughout the entire winding.

13. Winding machine according to claim 10, wherein, in use:
the body of the rotor is kept stationary in the spindle or support and the wire guiding cap is simultaneously moved in the rotor slots along the approach axis (Y), alternately in both directions, and the conducting wire is wound by the feeding unit on the wire guiding cap, which in turn provides to deposit it on the pole piece, or
the wire guiding cap is moved in the rotor slots along the approach axis (Y), alternately in both directions, and both the spindle together with the body of the rotor and the wire guiding cap and the pressing device integrated into the wire guiding cap are simultaneously rotated integrally on the approach axis (Y).

14. Winding machine according to claim 13, wherein the body of the rotor is supported by the spindle or support with the rotation axis (Z) of the rotor orthogonal and incident to the approach axis (Y), and wherein the wire guiding cap is susceptible to controlled displacements along the approach axis (y), in both directions, and wherein the wire guiding cap is sized such as to substantially enclose a pole piece of the rotor, and wherein the pressing device is a vise integrated into the wire guiding cap.

15. Winding machine according to claim 14, wherein the spindle together with the body of the rotor, the wire guiding cap and the vise integrated into the wire guiding cap are rotatable integrally on the approach axis (Y).

16. Winding machine according to claim 15, wherein the rotation of the wire guiding cap and the vise on the approach axis (Y) is dependent on the activation of the vise on at least one edge of a pole piece of the body of the rotor.

17. Winding machine according to claim 10, wherein the pressing device is a vise comprising two jaws movable radially with respect to the approach axis (Y) between a distal position, corresponding to the vise open, and a proximal position, corresponding to the vise closed.

18. Winding machine according to claim 17, comprising an actuator of the vise, in turn comprising a drive shaft extending on the approach axis (Y), a lever system constrained to the jaws and at least one spring continuously exerting a return force on the jaws to bring them to the proximal closed position of the vise, and
wherein the drive shaft is sliding on the approach axis (Y) between a position of engagement of the lever system, at which the lever system counteracts the action of the spring and keeps the jaws in the distal open position of the vise and a position of disengagement, at which the lever system does not counteract the action of the spring and the jaws are in the proximal closed position of the vise.

19. Winding machine according to claim 18, wherein the wire guiding cap is mounted on a rotation shaft rotatable on the approach axis (Y) and the drive shaft of the vise is inside and coaxial to the rotation shaft of the wire guiding cap.

20. Winding machine according to claim 10, wherein the wire guiding cap comprises two halves (20′, 20″) arranged on opposite sides with respect to the pressing device and movable, radially to the approach axis (Y), away from and towards each other, such as to modify the size of the wire guiding cap.

21. Winding machine according to claim 10, wherein the wire guiding cap is movable with respect to the pressing device along the approach axis (Y) for being inserted into the rotor slots whenever the pressing device is meshed on the body of the rotor.
